(19) United States
(12) Patent Application Publication
(10) Pub. No.: US 2018/0062978 A1
(43) Pub. Date: Mar. 1, 2018

(54) SLICED ARCHITECTURE FOR A CURRENT MODE DRIVER

(71) Applicant: FUJITSU LIMITED, Kawasaki-shi (JP)

(72) Inventors: Samir PARIKH, San Jose, CA (US); Nikola NEDOVIC, San Jose, CA (US)

(73) Assignee: FUJITSU LIMITED, Kawasaki-shi (JP)

(21) Appl. No.: 15/250,767

(22) Filed: Aug. 29, 2016

(51) Int. Cl. H04L 12/707; H04L 29/06

(52) U.S. Cl. CPC H04L 45/24; H04L 69/14

(57) ABSTRACT

A method may include hardwiring: a first dynamic input of M slices in a section of a sliced architecture to receive a main data sample; and a second dynamic input of each of X and Y slices to respectively receive a first or second delayed data sample, X, Y being subsets of M. A slice current may be multiplied with: the data sample in each of A of the M slices; and the first delayed data sample in each of B of the X slices. The method may also include summing: outputs of the A slices to obtain a weighted output current of the data sample; outputs of the B slices to obtain a weighted output current of the first delayed data sample; and the weighted output currents of the main data sample and of the first delayed data sample to obtain a net weighted output current of the section.

### FIELD

The embodiments discussed herein are related to a sliced architecture for a current mode driver.

### BACKGROUND

Data transmission in telecommunication and data communications may generally be done in two ways, namely serial communication and parallel communication. Serial communication involves sending of data one bit at a time via transmission or communication channel, whereas in parallel communication, more than one bit is transmitted via multiple parallel channels. The data communicated through each channel may be analog or digital. The channels may be optical fibers, computer buses, copper wire cables, etc., whereas the data may encompass infrared signals, microwave, electrical current, electrical voltage, etc. Different modulation or encoding methods such as Pulse Amplitude Modulation (PAM), Non Return to Zero (NRZ), or other modulation and/or encoding may be used.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method of pre-allocating data samples to each slice of a current mode driver may include, for M slices included in a section of a sliced architecture of the current mode driver, where the M slices include a subset of X slices and a subset of Y slices where X plus Y is less than or equal to M, hardwiring a first dynamic input of each of the M slices to receive a main data sample. The method may also include hardwiring a second dynamic input of each of the X slices to receive a first delayed data sample of the main data sample. The method may also include hardwiring a second dynamic input of each of the Y slices to receive a second delayed data sample of the main data sample. The method may also include, for each of A slices that are a subset of the M slices, multiplying a slice current with the main data sample. The method may also include summing outputs of the A slices to obtain a weighted output current of the main data sample. The method may also include, for each of B slices that are a subset of the X slices, multiplying the slice current with the first delayed data sample. The method may also include summing outputs of the B slices to obtain a weighted output current of the first delayed data sample. The method may also include summing the weighted output current of the main data sample and the weighted output current of the first delayed data sample to obtain a net weighted output current of the section.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example NRZ CML driver with a 5-tap FFE;

FIG. 2 illustrates an example sliced architecture with PAM4 encoding;

FIG. 3 illustrates an example implementation of a current mode driver circuit with a sliced architecture;

FIG. 4 is a flowchart of an example process to split a digital data sample into multiple parts;

FIG. 5 is a flowchart of an example process that may occur within each of multiple slices;

FIG. 6 illustrates aspects of an example section of a sliced architecture;

FIG. 7 illustrates an example sliced architecture;

FIG. 8 illustrates another example implementation of a current mode driver circuit with a sliced architecture;

FIG. 9 is a flowchart of an example method of generating a weighted current output signal from a first section of a sliced architecture;

FIG. 10 is a flowchart of an example method of generating a PAM4 encoded current signal; and

FIG. 11 is an example process of combining two parallel NRZ signals to generate a PAM4 signal, all arranged in accordance with at least one embodiment described herein.

### DESCRIPTION OF EMBODIMENTS

Some systems and methods disclosed here are directed to reducing the routing complexity of high-speed signal distribution, in high speed data transmitters. Within the context of a high-speed serial data transmitter providing a current-mode signal, a sliced architecture usually requires the connection of each slice to each fractional Unit Interval (UI) spaced data sample. In contrast, one or more techniques described herein may pre-select data samples for each slice individually which may reduce the routing complexity of these high-speed data signals. In some embodiments, Current Mode Logic (CML) drivers may be used.

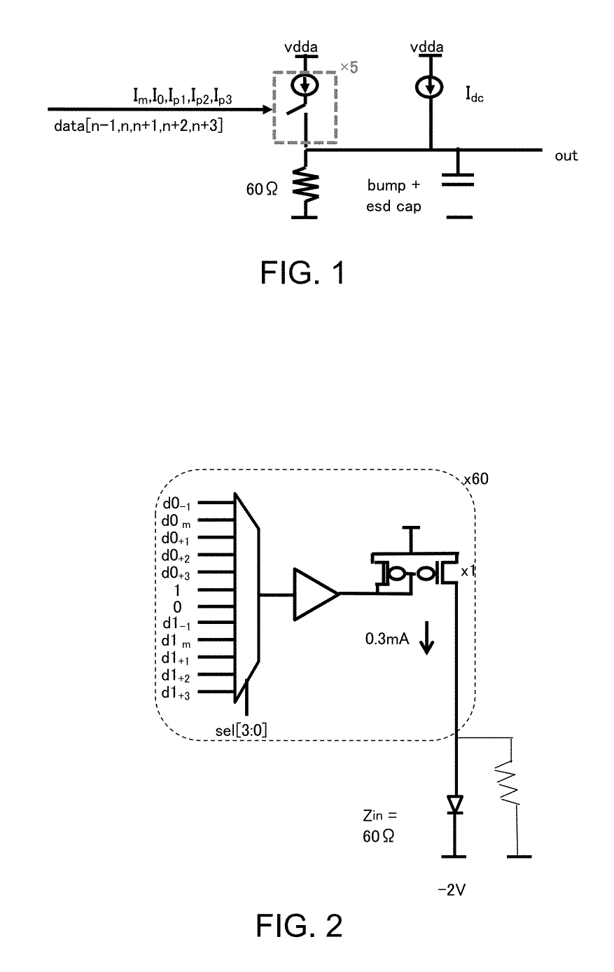

In this regard, FIG. 1 illustrates an example NRZ Current Mode Logic (CIVIL) driver with a 5-tap Feedforward Equalization (FFE). The NRZ CML driver of FIG. 1 includes a DC current source and a main current source in parallel with four equalization current sources, in which each data sample is multiplied with a corresponding current and summed together to get a final output current value. For example, current values Iₘ, I₀, Iₚ₁, Iₚ₂, and Iₚ₃ may be obtained depending on the value of the data samples data[n] (‘n−1’, ‘n+1’, ‘n+2’, and ‘n+3’). For example, for data sample n−1, current value Iₙ=Iₘ, for data sample n, current value Iₙ=I₀, for data sample n+1, current value Iₙ=Iₚ₁, for data sample n+2, current value Iₙ=Iₚ₂, and for data sample n+3, current value Iₙ=Iₚ₃. The data samples can be either ‘0’ or ‘1’, wherein for a ‘0’ data bit, the corresponding current value Iₙ may not be passed (switched OFF) and for a ‘1’ data bit, the corresponding current value Iₙ may be passed (switched ON). The total current value ‘out’ is obtained by summing the DC current value and all the current values with a corresponding data bit ‘1’, thus showing a 5 bit NRZ implementation.

As another example, FIG. 2 illustrates an example sliced architecture with PAM4 encoding. Considering 60 slices of the architecture of FIG. 2 (only one of which is illustrated in FIG. 2), with each slice having for example 10 inputs each for PAM4 encoding, the routing complexity of a 60-slice PAM4 architecture according to claim 4 would be 10*60.

In some embodiments, a sliced architecture of CML drivers, within for example, a Printed Circuit Board (PCB), or a package of a chip, or both, or a processor chip or circuitry, may be divided into sections such that each section includes a same number of slices of the driver circuit, where the slices may be of the CML drivers. High speed digital data signals may be provided as input to each of the slices of the driver circuit, in each section, such that the high speed data signals may include digital data samples or digital data bits. In some embodiments, the digital data samples or digital data bits may be a series of binary data bits, for example 0s and 1s. In some embodiments, each of the slices in each section may have only two high speed inputs in which a first high speed input receives a main data sample and a second high speed input receives a delayed data sample of the main data sample. The presence of only two high speed inputs in each slice may then provide a routing complexity of 2*(number of slices in each section), which may reduce the routing complexity compared to, e.g., the routing complexity of FIG. 2 and/or other sliced architectures.

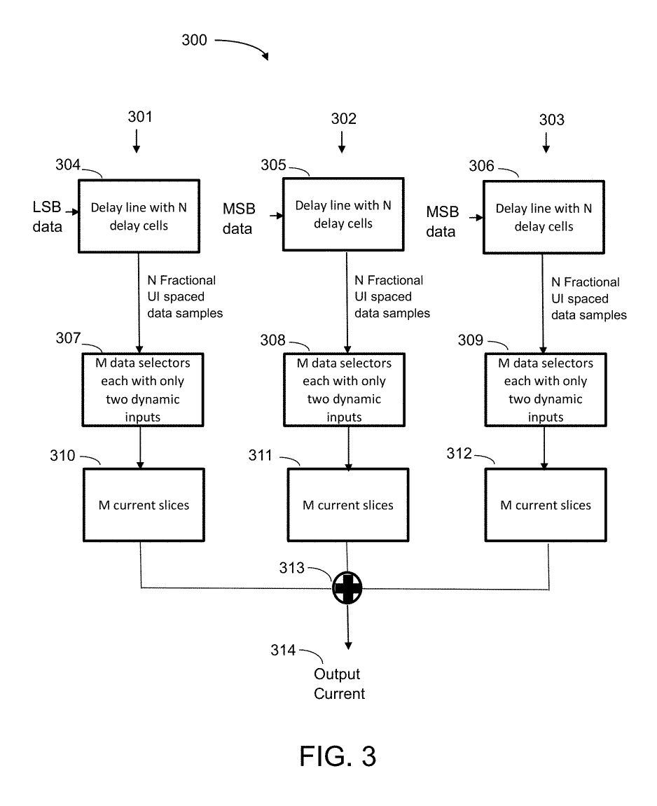

FIG. 3 illustrates an example implementation of a current mode driver circuit 300 with a sliced architecture (hereinafter “circuit 300”), arranged in accordance with at least one embodiment described herein. The circuit 300 may be configured to implement a process to output an analog current signal 314 for high speed data transmission. The sliced architecture of the circuit 300 may be divided into three sections in this example, including sections 301, 302, and 303. Each section may include a similar number of slices. A least significant bit (LSB) data sample and a most significant bit (MSB) data sample may be fed into each section 301, 302, 303 of the circuit 300. The circuit 300 may additionally include multiple delay lines 304, 305, 306 and M data selectors 307, 308, 309.

In some current mode driver circuits described herein, each current mode driver circuit may have a number of sections that is equal to 2n−1 for n-bit data. By way of example, current mode driver circuits according to some embodiments described herein may have 3 sections (as in FIG. 3) for 2-bit data, 7 sections for 3-bit data, 15 sections for 4-bit data, and so on.

In FIG. 3 for 2-bit data (e.g., from which an LSB data sample and MSB data sample without any intermediate data samples may be derived), a single section 301 receives the LSB data sample and two sections 302, 303 each receive the MSB data sample. More generally, the allocation of data samples (e.g., LSB, MSB, or intermediate) to sections may be made based on a weight w of each data sample, where each data sample is provided to 2^{w} sections. The LSB of each n-bit data may have a weight w of 0, a first intermediate bit (e.g., next to the LSB) may have a weight w of 1, a second intermediate bit (e.g., next to the first intermediate bit) may have a weight w of 2, . . . and the MSB may have a weight w of n−1.

Returning to FIG. 3, each of the delay lines 304, 305, 306 may include N delay cells and may be configured to generate one or more delayed data samples of the corresponding data sample received by the delay line 304, 305, 306. The delayed data samples output by each of the delay lines 304, 305, 306 are referred to in FIG. 3 as “N Fractional UI spaced data samples”). The delayed data samples output by the delay lines 304, 305, 306 together with main data samples may be fed into the M data selectors 307, 308, 309.

Each of the M data selectors 307, 308, 309 may include only two high speed inputs, or some other number of inputs. The M data selectors 307, 308, and 309 may each be coupled to a corresponding one of M current slices 310, 311, 312. In an example embodiment, each of the M current slices 310, 311, 312 includes a current mode digital to analog converter (DAC) circuit. Outputs of the M current slices 310, 311, 312 may be summed by a summer 313, which outputs the analog current signal 314. In some embodiments, M may include 10, 20, 30, 40, or other number of slices.

Each section 301, 302, 303 may include M slices of the sliced architecture, for a total of 3*M slices in the sliced architecture, where each slice includes one of M data selectors 307, 308, or 309 and one of M current slices 310, 311, or 312.

There may be N−1 number of delayed data samples of the main data samples within each section 301, 302, 303. Within each section 301, 302, 303, a delay line with N delay cells may be used to create the N Fractional UI spaced data samples. Although illustrated as discrete blocks, various blocks may be divided into additional blocks, combined into fewer blocks, or eliminated, depending on the desired implementation. The above blocks are described further in detail through the following figures.

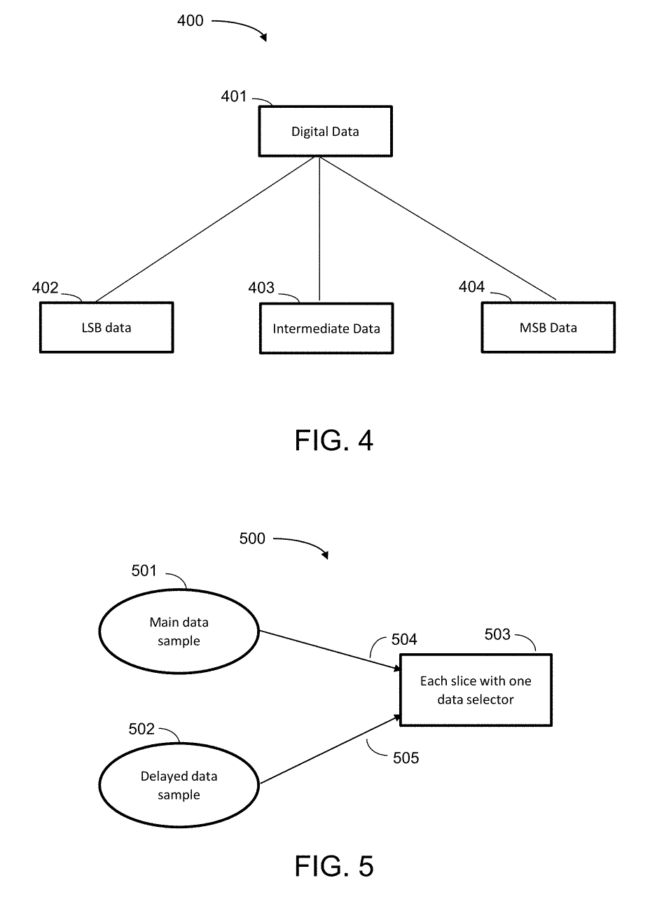

FIG. 4 is a flowchart of an example process 400 to split a digital data 401 into multiple parts, arranged in accordance with at least one embodiment described herein. The process 400 may extract individual series of data bits or data samples from the digital data 401. The digital data 401 may be a part of a data packet being received via a high speed serial transmitter channel, and the digital data 401 may be split into multiple parts. For example, the digital data 401 may be divided into a Least Significant Bit (LSB) 402, one or more intermediate bits 403, and a Most Significant Bit (MSB) 404. Although illustrated as discrete blocks, various blocks may be divided into additional blocks, combined into fewer blocks, or eliminated, depending on the desired implementation.

In some embodiments, the LSB 402 is a bit in an n-bit number that has a least potential value or lowest value. The MSB 404 represents a bit in the n-bit number with a largest value, while the one or more intermediate bits 403 represents the corresponding one or more bits in the n-bit number with value(s) between the lowest and largest value. For example, in terms of binary data, the LSB 402 may include a 0th bit in an 8-bit data, while the MSB 404 may include a 7th bit in the 8-bit data, while the one or more intermediate bits 403 may include six intermediate bits, including the 1st bit to the 6th bit in the 8-bit data.

FIG. 5 is a flowchart of an example process 500 that may occur within each slice 503, arranged in accordance with at least one embodiment described herein. The slice 503 of FIG. 5 may include or correspond to one of the slices of FIG. 3. Accordingly, the process 500 may occur or be implemented within each of the slices of FIG. 3.

In some embodiments, delayed data samples 502 of a main data sample 501 may be generated. The main data sample 501 may include or correspond to the LSB 402, the one or more intermediate bits 403, or the MSB 404 of FIG. 4, for instance. In some embodiments, fractional UI FFEs that include tapped delay lines, may be used to generate each main data sample 501 and each delayed data sample 502. The main data sample 501 and the delayed data sample 502 may be provided as inputs to a data selector within the slice 503, such that each data selector within a corresponding slice 503 of each section (e.g., sections 301, 302, and 303 of FIG. 3) within the current mode logic sliced architecture receives the corresponding main data sample 501 and delayed data sample 502.

The data selector of the slice 503 that receives the main data sample 501 may include or correspond to a data selector of the M data selectors 307, of the M data selectors 308, or of the M data selectors 309 of FIG. 3. In some embodiments, each data selector may include a 4:1 data selector in which two inputs are fixed and two inputs are dynamic (or high speed) inputs of the data selector. A first fixed input may be 1 and a second fixed input may be 0. The fixed inputs may be used as a means to switch a slice ON or OFF. The dynamic inputs may receive the main data sample 501 and the delayed data sample 502. Although illustrated as discrete blocks, various blocks may be divided into additional blocks, combined into fewer blocks, or eliminated, depending on the desired implementation.

In some embodiments, the main data sample 501 may include an LSB (such as the LSB 402 of FIG. 4), an intermediate bit (such as one of the one or more intermediate bits 403 of FIG. 4), or an MSB (such as the MSB 404 of FIG. 4). Alternatively or additionally, the main data sample 501 may include an LSB, an intermediate bit, or an MSB of a 2-bit data, a 4-bit data, an 8-bit data, a 16-bit data, a 32-bit data, a 64-bit data, or data of some other size.

In some embodiments, the main data sample 501 may be generated using a fractional UI FFE implemented in both NRZ and PAM4 modes of signaling. In some embodiments, the FFE may use only a NRZ mode modulation scheme. In some embodiments, the FFE may include a 5-tap FFE. In some other embodiments, the FFE may include 2 taps, 3 taps, 4 taps, 6 taps, or some other number of taps. In some embodiments, the 5-tap FFE may be used to create multiple delayed data samples 502 of the main data sample 501, where a given slice 503 may be pre-allocated to receive the main data sample 501 and only one of the delayed data samples 502 created by the 5-tap FFE. Each delayed version of the main data sample 501 may be produced at a successive one of the delay line taps. In some embodiments, the delayed data samples 502 may be obtained by delaying the main data sample 501. In some embodiments, the delayed data samples 502 may include a series of least significant bits, at different points of time, in the event a delay time is equal to a bit period. In some other embodiments, in the event the delay time is less than or greater than the bit period, the delayed data sample 502 may include data bits at the delayed point of time. The delaying of the main data sample 501 may be done using delay lines and shift registers, where each tap of the shift register represents a unit delay. In some embodiments, an N-fold delay line with N shift registers may be used to generate N data samples, including a main data sample 501 and N−1 number of delayed data samples 502. In some embodiments, buffers may be used instead of registers to store the delayed samples temporarily, while they are in transit and are being provided as the two inputs to the two dynamic inputs of the data selectors in each slice 503.

In some embodiments, each slice 503 may include a data selector with four inputs, two of which may be fixed 0 and 1 inputs, whereas the other two may be dynamic inputs, each configured to receive the main data sample 501 or one of the delayed data samples 502. In particular, a first dynamic input 504 of the data selector may be configured to receive the main data sample 501, and a second dynamic input 505 of the data selector may be configured to receive one of the delayed data samples 502. In some embodiments, each of the delayed data samples 502, generated from each of the taps of the FFE, may be received as input into specific number of slices 503 in each section of the sliced architecture.

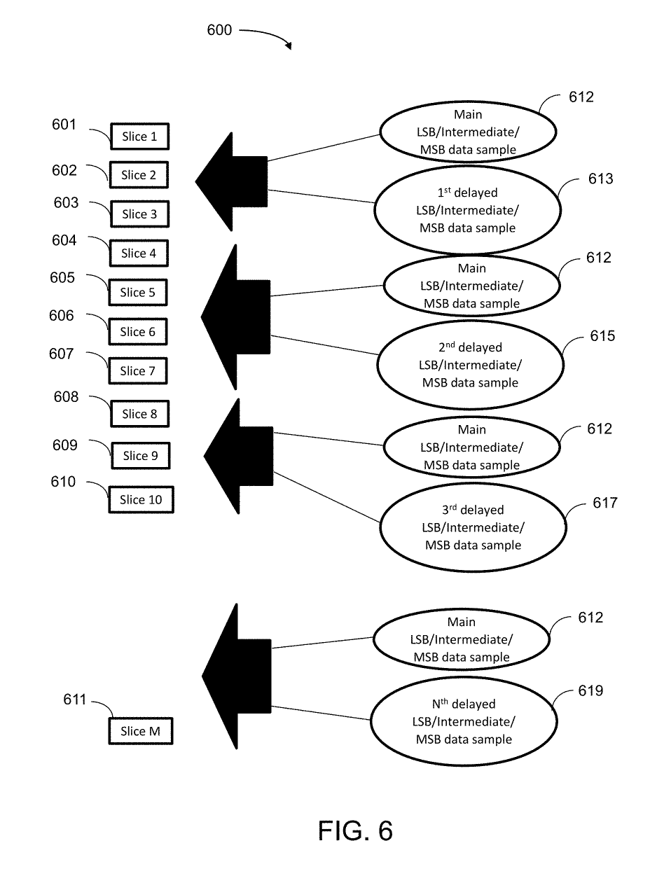

FIG. 6 illustrates aspects of an example section 600 of the sliced architecture, arranged in accordance with at least one embodiment described herein. The section 600 may include or correspond to the section 301, the section 302, or the section 303 of FIG. 3, for instance. As illustrated, the section 600 of FIG. 6 includes various slices 601-611, each of which may individually include or correspond to the slice 503 of FIG. 5, and each of which includes one data selector. The section 600 may include M number of slices 601-611. Within the section 600, each of the slices 601-611 may be configured to receive only two pre-allocated inputs at the first and second dynamic inputs of the corresponding data selectors. In some embodiments, the first and second dynamic inputs may include high speed inputs. Although illustrated as discrete blocks, various blocks may be divided into additional blocks, combined into fewer blocks, or eliminated, depending on the desired implementation.

In some embodiments, a 1st slice 601 to an Mth slice 611 may represent a total number of M slices in the section 600. Each of the slices 601 through 611 may be hardwired to receive a main data sample 612 as one of the two dynamic inputs to each of the slices 601 through 611. A second dynamic input to each of the slices 601 through 611 may be hardwired to receive a corresponding one of multiple delayed data samples, such as, for example, a first delayed data sample 613, a second delayed data sample 615, a third delayed data sample 617, up to an Nth delayed data sample 619.

In some embodiments, the main data sample 612 may include or correspond to the main data sample 501, while the delayed data samples 613, 615, 617, 619, may include or correspond to the delayed data sample 502 of FIG. 5. The N number of delayed data samples may be created using fractional UI FFEs, having N number of taps or N number of delay cells in delay lines. In some embodiments, each of the delayed data samples 613, 615, 617, 619, may be received as inputs into specific number of slices within the section 600. In some embodiments, the main data sample 612 and a corresponding one of the delayed data samples 613, 615, 617, 619, may be received as inputs at two dynamic inputs of a corresponding 4:1 data selector within each slice 601 to 611, such that the main data sample 612 is received as the first dynamic input at the corresponding 4:1 data selector, and a corresponding one of the delayed data samples 613, 615, 617, 619 may be received as the second dynamic input to the corresponding 4:1 data selector.

More generally, pre-allocation includes hardwiring the two high speed dynamic inputs of each selector such that one input is hardwired to receive the main data sample, and the other input is hardwired to receive one of the delayed data samples. In some embodiments, the main data sample 612 may be hardwired to be received at the first dynamic input of each data selector in each slice, while the second dynamic input of the data selectors may be hardwired to receive one of multiple delayed data samples such as 613, 615, 617, 619, in the two dynamic input system. For example, based on a system simulation, A number of data selectors may be hardwired to receive a first delayed data sample at the second dynamic input, B number of data selectors may be hardwired to receive a second delayed data sample at the second dynamic input, C number of data selectors may be hardwired to receive a third delayed data sample at the second dynamic input, and D number of data selectors may be hardwired to receive a fourth delayed data sample at the second dynamic input. For each of the data selectors, the output can be selected between the main data sample and the corresponding delayed data sample for that specific data selector.

For example, in some embodiments, a specific number of slices 601-611 in the section 600 may be pre-allocated to receive a specific delayed data sample as the second dynamic input at the corresponding data selectors, for example delayed data samples 613, 615, 617, or 619. In some embodiments, for example, slices 601, 602, and 603 may be pre-allocated to receive the first delayed data sample 613 as the second dynamic input; slices 604, 605, 606, and 607 may be pre-allocated to receive the second delayed data sample 615 as the second dynamic input; slices 608, 609, and 610 may be pre-allocated to receive the third delayed data sample 617 as the second dynamic input, and so on, until all the slices up to the Mth slice 611 is pre-allocated to receive a specific one of the delayed data samples as the second dynamic input. In some embodiments, the pre-allocation of a specific delayed data sample, for example 613, 615, 617, or 619, into specific slices, for example 601, 602, 603, 604, 605, 606, 607, 608, 609, 610, 611, etc., may be initially coded into a system simulation, such that it is hardwired into the system. In some embodiments, buffers may be programmed to hold a particular bit of the delayed data samples 613 and/or 615 and/or 617 and/or 619, for a given amount of time, such that all the slices meant to receive a particular delayed data sample may receive the pre-allocated particular delayed data sample. A system control may allow the selector to select and send the main data sample or the delayed data sample connected to it, as the output. In some embodiments, hardwiring the two inputs to each of the data selectors, in each slice 503, may aid in reducing the routing complexity of the high speed signal distribution. In this example, the routing complexity may be 2*M, where M is the number of slices, each of which receives only two dynamic inputs.

In other embodiments, each data selector may have three or some other number of dynamic inputs, one of which is hardwired to receive the main data sample, and the other two (or other number) of which is hardwired to receive a corresponding one of the delayed data samples. While the routing complexity here may be greater than 2*M, such as 3*M where each data selector has three dynamic inputs, the routing complexity may nevertheless be less than, e.g., the example of FIG. 2.

In some embodiments, there may be multiple sections 600 within the sliced architecture. In some embodiments, each of the sections 600 may include NRZ mode of encoding, for example, sections 301, 302 and 303 of FIG. 3 may each individually be configured to include NRZ mode of encoding, such that the fractional UI FFEs in each section is operational in the NRZ mode of encoding.

In FIG. 6, each main data sample 612 is labeled as “Main LSB/Intermediate/MSB data sample” as shorthand to describe possible content of the main data sample 612. In some embodiments, each main data sample 612 may include a single one of a main LSB data sample, an intermediate data sample, or a main MSB data sample, but not more than one of the foregoing.

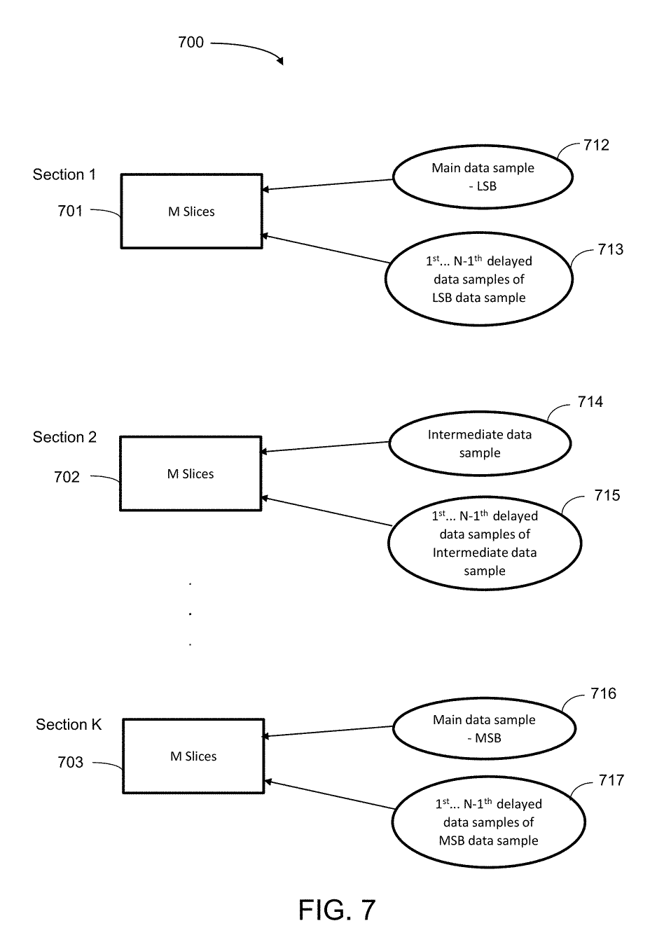

FIG. 7 illustrates an example sliced architecture 700, arranged in accordance with at least one embodiment described herein. The sliced architecture 700 may include multiple sections, such as, for example, a first section 701, a second section 702, and a Kth section 703. Sections 701, 702 or 703 may include or correspond to section 600 of FIG. 6 and/or sections 301, 302 and 303 of FIG. 3. In some embodiments, each of the sections 701, 702 through to 703, may include M number of slices and each of the M slices may receive two dynamic inputs. In some embodiments, the dynamic inputs may include high speed inputs. Although illustrated as discrete blocks, various blocks may be divided into additional blocks, combined into fewer blocks, or eliminated, depending on the desired implementation.

In some embodiments, the first section 701 that includes M slices may receive in each slice, as a first dynamic input, an LSB main data sample 712 such that the LSB main data sample 712 may include an LSB of a data sample. Each of the M slices of the first section 701 may also receive as a second dynamic input a corresponding one of N−1 delayed LSB data samples 713. For instance, one subset of the M slices of the first section 701 may be pre-allocated to receive a first delayed data sample 713 of the LSB main data sample 712, another subset of the M slices of the first section 701 may be pre-allocated to receive a second delayed data sample 713 of the LSB main data sample 712, and so on.

In some embodiments, the second section 702 that includes M slices may receive in each slice, as a first dynamic input, an intermediate main data sample 714 such that the intermediate main data sample 714 may include an intermediate data bit of the data sample. Each of the M slices of the second section 702 may also receive as a second dynamic input a corresponding one of N−1 delayed intermediate data samples 715. For instance, one subset of the M slices of the second section 702 may be pre-allocated to receive a first delayed data sample 715 of the intermediate main data sample 714, another subset of the M slices of the second section 702 may be pre-allocated to receive a second delayed data sample 715 of the intermediate main data sample 714, and so on.

In some embodiments, the Kth section 703 that includes M slices may receive in each slice, as a first dynamic input, an MSB main data sample 716 such that the MSB main data sample 716 may include a MSB of the data sample. Each of the M slices of the Kth section 703 may also receive as a second dynamic input a corresponding one of N−1 delayed MSB data samples 717. For instance, one subset of the M slices of the third section 703 may be pre-allocated to receive a first delayed data sample 717 of the MSB main data sample 716, another subset of the M slices of the third section 703 may be pre-allocated to receive a second delayed data sample 717 of the MSB main data sample 716, and so on.

In some embodiments, and as described above, data samples of a digital data may be distributed among K sections in the following way: For e.g., for an n-bit data sample, the number of sections K=(2ⁿ−1), such that, the 1st data bit (the LSB) is the input to first 2⁰ number of sections out of the K sections; the 2nd data bit is the input to next 2¹ number of sections out of the K sections; the 3rd data bit is the input to next 2² number of sections out of the K sections; . . . the nth data bit (the MSB) is the input to last 2ⁿ−1 number of sections out of the K sections, whereas the 2nd to the (n−1)th data bits are the intermediate bits.

Each of the K sections may also receive delayed data samples of the main data samples, along with the main data samples (e.g., the LSB, the intermediate bits, and the MSB). In some embodiments, each of the set of sections receiving a specific main data sample and corresponding delayed data samples may generate an output current signal corresponding to the main data sample and an output current signal corresponding to the delayed data samples. The output current signal from each of the set of sections may be an NRZ encoded output. The combination of the NR encoded outputs from each of the K sections may form a PAM-(K+1) output current. For example, the combination of three such NRZ encoded output may form a PAM-4 output current signal. For example, in some embodiments, with a 2-bit data sample, the data bits would be input to 3 sections, such that a first section would receive the LSB of the 2-bit data sample and delayed data samples of the LSB; a second section would receive the MSB of the 2-bit data sample and delayed data samples of the MSB; and a third section would also receive the MSB of the 2-bit data sample and delayed data samples of the MSB. An output current signal, from the first section configured to receive LSB data samples and delayed LSB data samples, may be a first NRZ encoded output. An output current signal from the second section and the third section combined, configured to receive MSB data samples and delayed MSB data samples may be summed together to form a second NRZ encoded output. The first NRZ encoded output and the second NRZ encoded output may be summed to obtain a net PAM4 output current signal, wherein the second NRZ encoded output may have twice the weight of that of the first NRZ encoded output.

Further, for example, for a 3-bit data, there may be 7 sections, such that a first section would receive the LSB of the 3-bit data; the next 2 sections would receive the intermediate bit of the 3-bit data; and the last 4 sections would receive the MSB of the 3-bit data. Output current from all of the 7 sections combined would form a PAM-8 output current signal. As another example, for a 4-bit data, there may be 15 sections, such that a first section would receive the LSB of the 4-bit data; the next 2 sections would receive the first intermediate bit of the 4-bit data; the next 4 sections would receive the second intermediate bit of the 4-bit data; and the last 8 sections would receive the MSB of the 4-bit data. Output current from all of the 15 sections combined would form a PAM-16 output current signal.

In some embodiments, an output of each data selector in each of the M slices may be converted to an output analog current signal. In some embodiments, the conversion may be done using a current mode DAC circuit within each slice, as suggested above with respect to the M current slices 310, 311, 312 (each current slice being implemented as a current mode DAC circuit) of FIG. 3. In some embodiments, all outputs from the M slices of the first section 701 may be summed together to form an output of the first section 701; all outputs from the M slices of the second section 702 may be summed together to form an output of the second section 702; and all outputs from the M slices of the Kth section 703 may be summed together to form an output of the Kth section 703. The output of the first section 701, the output of the second section 702, and the output of the Kth section 703 may be summed to obtain the net output current signal to be transmitted. In some embodiments, each of the first, second, up to Kth sections 701, 702, 703 may be configured to operate in the NRZ mode of encoding.

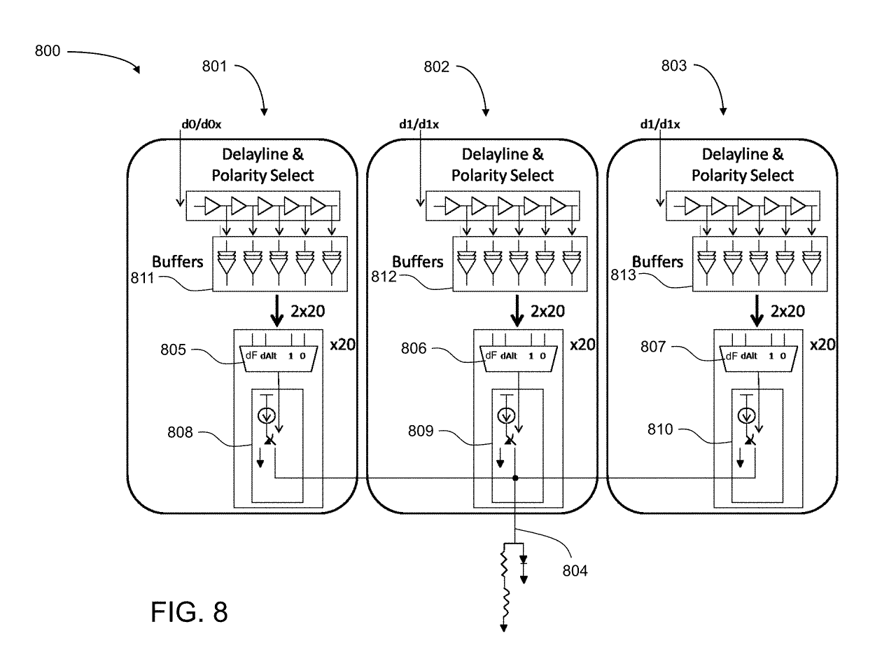

FIG. 8 illustrates an example implementation of a current mode driver circuit 800 with the sliced architecture 700 (hereinafter “circuit 800”), arranged in accordance with at least one embodiment described herein. The circuit 800 may include or correspond to the circuit 300 of FIG. 3. The circuit 800 is divided for example, into three sections: a first section 801, a second section 802 and a third section 803; such that the data sample being received is a 2-bit data sample. The LSB of the 2-bit data thus may be received as input in the first section 801 and the MSB of the 2-bit data sample may be received as input in each of the second and third sections 802 and 803. In other embodiments, the circuit 800 may be implemented with a single one of the sections 801, 802, or 803 to generate a single NRZ encoded output. In comparison, the circuit 800 with all three sections 801-803 together may be configured to generate a PAM4 encoded output.

The first section 801, the second section 802 and the third section 803 may each include M slices. In the illustrated embodiment of FIG. 3, M is 20 such that each of the first section 801, the second section 802 and the third section 803 includes 20 slices. In other embodiments, M is some other number. The first section 801, the second section 802, and the third section 803 may respectively include or correspond to the sections 301, 302, and 303 of FIG. 3 and/or the first section 701, the second section 702 and the Kth section 703 of FIG. 7. In some embodiments, each of the 20 slices in each of the first, second, and third sections 801, 802, 803, may include a 4:1 data selector 805, 806, or 807, with two fixed inputs and two dynamic inputs. The dynamic inputs may be configured to receive two high speed inputs. A first dynamic input is labeled for each of the three data selectors 805-807 illustrated in FIG. 8 as “dF.” A second dynamic input is labeled for each of the three data selectors 805-807 illustrated in FIG. 8 as “dAlt.” In some embodiments, both the dynamic inputs to the data selector 805, 806, or 807 in each slice may be pre-coded within a system simulation, such that both the dynamic inputs to the data selector 805, 806, 807 in each slice is pre-allocated. Although illustrated as discrete blocks, various blocks may be divided into additional blocks, combined into fewer blocks, or eliminated, depending on the desired implementation.

In some embodiments, the first section 801 may be configured to receive a main data sample, such as, a main LSB data sample d0. In some embodiments, the main LSB data sample d0 and a complement of the main LSB data sample d0x may be transmitted in parallel via a pseudo differential input line as input to each of the sections. Alternatively or additionally, the second section 802 and the third section 803 may each be configured to receive a main data sample such as a main MSB data sample d1. In some embodiments, the main MSB data sample d1 and a complement of the main MSB data sample d1x may be transmitted in parallel via a pseudo differential input line as input to each of the sections. Both the main LSB data sample d0 and the main MSB data sample d1 may be passed through a corresponding delay line (each labeled “Delayline & Polarity Select” in FIG. 8). In some embodiments, each delay line may include a 5-tap fractional UI FFE. Each 5-tap fractional UI FFE may generate one or more delayed data samples of a corresponding one of the main LSB data sample or the main MSB data sample and may output the one or more delayed data samples with a corresponding one of the main LSB data sample d0 or the main MSB data sample d1. The one or more delayed data samples may be designated as dm1, dp1, dp2, dp3, and so on as a convenient shorthand to refer to a delayed data sample that has been delayed by negative one delay period (in the case of dm1), positive one delay period (in the case of dp1), positive two delay periods (in the case of dp2), positive three delay periods (in the case of dp3), and so on. Thus, the delayed data sample dm1 may include a data sample that follows the main data sample d0 or d1 by one delay period, while the delayed data samples dp1, dp2, and dp3 may be the data samples that precede the main data sample d0 or d1 by one, two, or three delay periods.

The outputs of each delay line may be stored, at least temporarily, in N buffers 811, 812, or 813 included in a corresponding one of the first, second, or third section 801, 802, or 803. The N buffers 811, 812, and 813 in each of the first, second, and third sections 801, 802, and 803 may be coupled to a corresponding one of the delay lines. The M slices in each of the first, second, and third sections 801, 802, and 803 may be coupled to the N buffers 811, 812, and 813. For instance, the first dynamic input of each of the data selectors 805 may be coupled to a first buffer of the N buffers 811 that stores the main LSB data sample, while the second dynamic input of each of the data selectors 805 may be coupled to a corresponding other buffer of the N buffers 811 that stores a corresponding one of the delayed data samples of the main LSB data samples pre-allocated to the corresponding data selector 805, as described below. The data selectors 806 and 807 are similarly coupled to the N buffers 812 and 813.

In some embodiments, in the first section 801, the first dynamic inputs of the data selectors 805 in the 20 slices may each be configured to receive the main LSB data sample d0. In these and other embodiments, the second dynamic input of each of the data selectors 805 may be pre-allocated to receive a corresponding one of the delayed data samples dm1, dp1, dp2, or dp3, of the main LSB data sample d0. For instance, one subset of the data selectors 805 may be pre-allocated to receive the delayed data sample dm1 at the second dynamic input, another subset of the data selectors 805 may be pre-allocated to receive the delayed data sample dp1 at the second dynamic input, and so on.

Each data selector 805 of each slice in the first section 801 may output one of the two data samples received on one of each data selector's two dynamic inputs. The main LSB data sample d0 may be the first dynamic input of all the 20 data selectors 805. In some embodiments, for example, for the first 6 slices of the 20 slices, the delayed data sample dm1 may be the second dynamic input of each corresponding data selector 805; for the next 8 slices of the 20 slices, the delayed data sample dp1 may be the second dynamic input of each corresponding data selector 805; for the next 4 slices of the 20 slices, the delayed data sample dp2 may be the second dynamic input of each corresponding data selector 805; and, for the last 2 slices of the 20 slices, the delayed data sample dp3 may be the second dynamic input of each corresponding data selector 805. Different combination of the main LSB data samples and the delayed data samples may be the output from the first section 801. Each of the 20 data selectors may transmit either of the two dynamic inputs as the corresponding output.

More generally, each of the data selectors 805 of the first section 801 may output one of the main LSB data sample d0 or a corresponding one of the delayed data samples dm1, dp1, dp2, or dp3. For instance A1 of the M data selectors 805 may output the main LSB data sample d0, B1 of the M data selectors 805 may output a first delayed data sample of the main LSB data sample d0 (e.g., dm1), C1 of the M data selectors 805 may output a second delayed data sample of the main LSB data sample d0 (e.g., dp1), and so on. A sum of A1, B1, C1, and so on may be equal to or less than M. In some embodiments, one of the two static inputs of the 4:1 data selectors 805 is ‘0’, which may be used to switch OFF any particular data selector 805 that is ON, which may make the sum of A1, B1, C1, etc., to be less than M. The other of the two static inputs of the 4:1 data selectors 805 is ‘1’, which may be used to switch ON any particular data selector 805 that is OFF.

In some embodiments, a digital output of each of the data selectors 805 in each slice may be converted to an output analog current signal using a corresponding current mode DAC circuit 808 coupled to an output of the corresponding data selector 805 of the first section 801. In some embodiments, the output analog current signals of each of the 20 slices generated by 20 corresponding current mode DAC circuits 808 in the 20 slices of the first section 801 may be summed to obtain the net output current of the first section 801.

In some embodiments, in the second section 802, the first dynamic inputs of the data selectors 806 in the 20 slices may each be configured to receive the main MSB data sample d1. In these and other embodiments, the second dynamic input of each of the data selectors 806 may be pre-allocated to receive a corresponding one of the delayed data samples dm1, dp1, dp2, or dp3, of the main MSB data sample d1. For instance, one subset of the data selectors 806 may be pre-allocated to receive the delayed data sample dmf at the second dynamic input, another subset of the data selectors 806 may be pre-allocated to receive the delayed data sample dp1 at the second dynamic input, and so on.

Each data selector 806 of each slice in the second section 802 may output one of the two data samples received on one of each data selector's two dynamic inputs. The main MSB data sample d1 may be the first dynamic input of all the 20 data selectors 806. In some embodiments, for example, for the first 6 slices of the 20 slices, the delayed data sample dm1 may be the second dynamic input of each corresponding data selector 806; for the next 8 slices of the 20 slices, the delayed data sample dp1 may be the second dynamic input of each corresponding data selector 806; for the next 4 slices of the 20 slices, the delayed data sample dp2 may be the second dynamic input of each corresponding data selector 806; and, for the last 2 slices of the 20 slices, the delayed data sample dp3 may be the second dynamic input of each corresponding data selector 806. Different combination of the main MSB data samples and the delayed data samples may be the output from the second section 802. Each of the 20 data selectors may transmit either of the two dynamic inputs as the corresponding output.

More generally, each of the data selectors 806 of the second section 802 may output one of the main MSB data sample d1 or a corresponding one of the delayed data samples dm1, dp1, dp2, or dp3. For instance A2 of the M data selectors 806 may output the main MSB data sample d1, B2 of the M data selectors 806 may output a first delayed data sample of the main MSB data sample d1 (e.g., dm1), C2 of the M data selectors 806 may output a second delayed data sample of the main MSB data sample d1 (e.g., dp1), and so on. A sum of A2, B2, C2, and so on may be equal to or less than M. In some embodiments, one of the two static inputs of the 4:1 data selectors 806 is ‘0’, which may be used to switch OFF any particular data selector 806 that is ON, which may make the sum of A2, B2, C2, etc., to be less than M. The other of the two static inputs of the 4:1 data selectors 806 is ‘1’, which may be used to switch ON any particular data selector 806 that is OFF.

In some embodiments, a digital output of each of the data selectors 806 in each slice may be converted to an output analog current signal using a corresponding current mode DAC circuit 809 coupled to an output of the corresponding data selector 806 of the second section 802. In some embodiments, the output analog current signals of each of the 20 slices generated by 20 corresponding current mode DAC circuits 809 in the 20 slices of the second section 802 may be summed to obtain the net output current of the second section 802.

In some embodiments, in the third section 803, the first dynamic inputs of the data selectors 807 in the 20 slices may each be configured to receive the main MSB data sample d1. In these and other embodiments, the second dynamic input of the data selectors 807 may be pre-allocated to receive a corresponding one of the delayed data samples dm1, dp1, dp2, or dp3, of the main MSB data sample d1 (or d2, as the case may be). For instance, one subset of the data selectors 807 may be pre-allocated to receive the delayed data sample dm1 at the second dynamic input, another subset of the data selectors 807 may be pre-allocated to receive the delayed data sample dp1 at the second dynamic input, and so on.

Each data selector 807 of each slice in the third section 803 may output one of the two data samples received on one of each data selector's two dynamic inputs. The main MSB data sample d1 may be the first dynamic input of all the 20 data selectors 807. In some embodiments, for example, for the first 6 slices of the 20 slices, the delayed data sample dm1 may be the second dynamic input of each corresponding data selector 807; for the next 8 slices of the 20 slices, the delayed data sample dp1 may be the second dynamic input of each corresponding data selector 807; for the next 4 slices of the 20 slices, the delayed data sample dp2 may be the second dynamic input of each corresponding data selector 807; and, for the last 2 slices of the 20 slices, the delayed data sample dp3 may be the second dynamic input of each corresponding data selector 807. Different combination of the main MSB data samples and the delayed data samples may be the output from the third section 803. Each of the 20 data selectors may transmit either of the two dynamic inputs as the corresponding output.

More generally, each of the data selectors 807 of the third section 803 may output one of the main MSB data sample d1 or a corresponding one of the delayed data samples dm1, dp1, dp2, or dp3. For instance A3 of the M data selectors 807 may output the main MSB data sample d1, B3 of the M data selectors 807 may output a first delayed data sample of the main MSB data sample d1 (e.g., dm1), C3 of the M data selectors 807 may output a second delayed data sample of the main MSB data sample d1 (e.g., dp1), and so on. A sum of A3, B3, C3, and so on may be equal to M. In some embodiments, one of the two static inputs of the 4:1 data selectors 807 is ‘0’, which may be used to switch OFF any particular data selector 807 that is ON, which may make the sum of A3, B3, C3, etc., to be less than M. The other of the two static inputs of the 4:1 data selectors 807 is ‘1’, which may be used to switch ON any particular data selector 807 that is OFF.

In some embodiments, a digital output of each of the data selectors 807 in each slice may be converted to an output analog current signal using a corresponding current mode DAC circuit 810 coupled to an output of the corresponding data selector 807 of the third section 803. In some embodiments, the output analog current signals of each of the 20 slices generated by 20 corresponding current mode DAC circuits 810 in the 20 slices of the third section 803 may be summed to obtain the net output current of the third section 803.

In some embodiments, the net output current of each of the first section 801, the second section 802, and the third section 803, may individually be a result of the NRZ mode FFE in each section, implemented upon each slice. Thus in some embodiments, output current signal of each of the three sections 801-803 may be individual and independent NRZ encoded current signals.

In some embodiments, the net output current of the second section 802 and the net output current of the third section 803 may be combined together to obtain a first NRZ encoded current signal, which may have double the weight of the net output current of the first section 801, which for example, may be a second NRZ encoded current signal. In some embodiments, the first NRZ encoded current signal and the second NRZ encoded current signal may be combined to obtain a total current output signal that is a PAM4 signal. For instance, combining the above-described first and second NRZ encoded current signals may result in a PAM4 signal 804 in FIG. 8. In some embodiments, the first NRZ encoded current signal and the second NRZ encoded current signal may be generated parallel to each other.

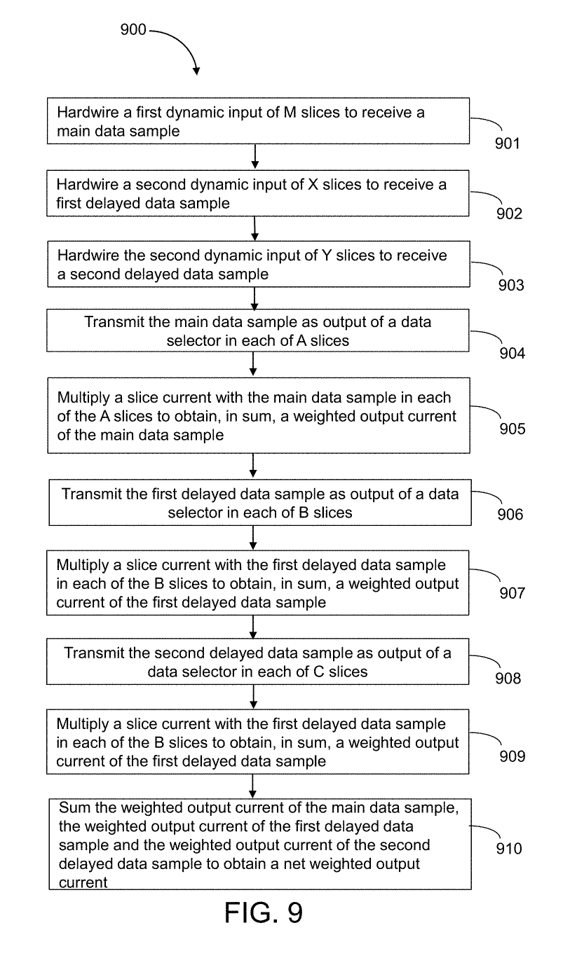

FIG. 9 is a flowchart of an example method 900 of generating a weighted current output signal from a first section of a sliced architecture, arranged in accordance with at least one embodiment described herein. The sliced architecture may include a single section with M slices or multiple sections, each with M slices. Each of the M slices may include a 4:1 data selector, with two dynamic inputs and two static inputs including 0 and 1. In some embodiments, the method 900 may be implemented simultaneously and/or in parallel by multiple sections of a sliced architecture to generate multiple net weighted output currents (one each from each section) that are summed together. Although illustrated as discrete blocks, various blocks may be divided into additional blocks, combined into fewer blocks, or eliminated, depending on the desired implementation. The method 900 may be implemented in whole or in part by, e.g., the circuit 800 of FIG. 8.

At 901, a first dynamic input of the M slices may be hardwired to receive a main data sample. Pre-allocating the first dynamic input of all the M slices may include hardwiring the first dynamic input of the data selectors included in the M slices to receive the main data sample from, e.g., a first buffer that stores, at least temporarily, the main data sample. In these and other embodiments, the first dynamic input of all the M slices may be hardwired to, e.g., the first buffer that stores the main data sample. The main data sample may be transmitted through some or all or none of the M data selectors as output of the corresponding data selectors to be multiplied with a slice current by a corresponding current mode DAC circuit of the slice.

At 902, a second dynamic input of X slices may be hardwired to receive a first delayed data sample, the X slices being a subset of the total of M slices. Pre-allocating the second dynamic input of the X slices may include hardwiring the second dynamic input of the data selectors included in the X slices to receive the first delayed data sample from, e.g., a second buffer that stores, at least temporarily, the first delayed data sample. In these and other embodiments, the second dynamic input of the X slices may be hardwired to, e.g., the second buffer that stores the first delayed data sample. The first delayed data sample may be transmitted through some or all or none of the X data selectors as output of the corresponding data selectors to be multiplied with a slice current by a corresponding current mode DAC circuit of the slice.

At 903, the second dynamic input of Y slices may be hardwired to receive a second delayed data sample, the Y slices being a subset of the total of M slices. Pre-allocating the second dynamic input of the Y slices may include hardwiring the second dynamic input of the data selectors included in the Y slices to receive the second delayed data sample from, e.g., a third buffer that stores, at least temporarily, the second delayed data sample. In these and other embodiments, the second dynamic input of the Y slices may be hardwired to, e.g., the third buffer that stores the second delayed data sample. The second delayed data sample may be transmitted through some or all or none of the Y data selectors as output of the corresponding data selectors to be multiplied with a slice current by a corresponding current mode DAC circuit of the slice.

A sum of X and Y may be less than or equal to M. In some embodiments, the sum of X and Y may be less than M if there are Z slices, Z being another subset of M, that each have a second dynamic input hardwired to receive a third delayed data sample, and/or one or more other subsets of the slices M, where all slices within a given subset are hardwired to receive a corresponding delayed data sample. As used herein, variables X, Y, Z, M, N, A, B, C, D and/or other variables used to describe a number of sections, delay lines, slices, data selectors, buffers, and/or other components are all integers greater than or equal to 0.

At 904, the main data sample may be transmitted as output of the data selector of each of A slices, the A slices being a subset of the total of M slices, where 0≦A≦M.

At 905, a slice current may be multiplied with the main data sample in each of the A slices to obtain, in sum, a weighted output current of the main data sample. For instance, the A current mode DAC circuits that each receive the main data sample may multiply the main data sample with the slice current, and the resulting outputs of the A current mode DAC circuits may be combined as the weighted output current of the main data sample.

At 906, the first delayed data sample may be transmitted as output of the data selector of each of B slices, the B slices being a subset of the X slices, where 0≦B≦X.

At 907, a slice current may be multiplied with the first delayed data sample in each of the B slices to obtain, in sum, a weighted output current of the first delayed data sample. For instance, the B current mode DAC circuits that each receive the first delayed data sample may multiply the first delayed data sample with the slice current, and the resulting outputs of the B current mode DAC circuits may be combined as the weighted output current of the first delayed data sample.

At 908, the second delayed data sample may be transmitted as output of the data selector of each of C slices, the C slices being a subset of the total of Y slices, where 0≦C≦Y. A sum of A, B, and C may be less than or equal to M. In some embodiments, the sum of A, B, and C may be less than M in the event, e.g., the static input 0 of any of the data selectors is used to switch OFF any corresponding data selector, making the total number of active slices to be less than M.

At 909, a slice current may be multiplied with the second delayed data sample in each of the C slices to obtain, in sum, a weighted output current of the second delayed data sample. For instance, the C current mode DAC circuits that each receive the second delayed data sample may multiply the second delayed data sample with the slice current, and the resulting outputs of the C current mode DAC circuits may be combined as the weighted output current of the second delayed data sample.

Other subsets of slices hardwired to other delayed data samples may similarly have at least some of the data selectors of the corresponding subset of slices transmit the corresponding delayed data sample, each of which may be multiplied with the slice current and combined as the weighted output current of the corresponding delayed data sample.

At 910, the weighted output current of the main data sample, the weighted output current of the first delayed data sample and the weighted output current of the second delayed data sample may be summed to obtain a net weighted output current of the section. Where there are other weighted output currents of other corresponding delayed data samples, these may be summed together with the weighted output current of the main data sample, the weighted output current of the first delayed data sample, and the weighted output current of the second delayed data sample at block 901 to obtain the net weighted output current.

In some embodiments, one of B or C is equal to 0, while the other is equal to or greater than 1. Thus, notwithstanding each of the X slices may have its second dynamic input hardwired to receive the first delayed data sample and each of the Y slices may have its second dynamic input hardwired to receive the second delayed data sample, embodiments described herein may nevertheless be implemented by summing at block 910 the weighted output current of the main data sample and the weighted output current of a single delayed data sample (e.g., the first or second delayed data sample).

The method 900 of FIG. 9 may include one or more other steps or operations. For instance, the method 900 may additionally include generating the main data sample from a digital data (e.g., the digital data 401 of FIG. 4) using a fractional UI FFE. The method 900 may additionally include generating the delayed data sample of the main data sample by passing the main data sample to a delay line and/or generating multiple delayed data samples of the main data sample.

The method 900 may be performed for each of multiple sections, e.g., first, second, and third sections, of a current mode driver with a sliced architecture to obtain a net weighted output current for each section. The method 900 may additionally include extracting and storing an LSB in the first section as the main data sample for the first section, extracting and storing an MSB in the second section as the main data sample for the second section, and extracting and storing an MSB in the third section as the main data sample for the third section. Each of the net weighted output current of the first, second, and third sections may include NRZ encoding. The method 900 may additionally include summing the net weighted output current for the first section, the net weighted output current for the second section, and the net weighted output current for the third section to obtain a net weighted output current with PAM4 encoding.

Modifications or additions may be made to FIG. 9 and/or other FIGS. herein without limitation.

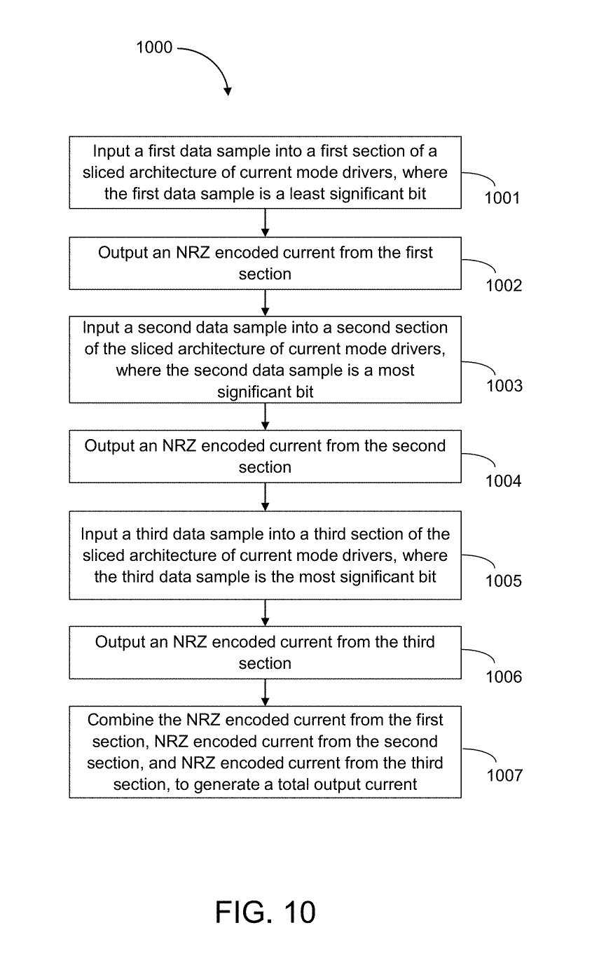

FIG. 10 is a flowchart of an example method 1000 of generating a PAM4 encoded current signal, arranged in accordance with at least one embodiment described herein. In some embodiments, a PAM4 signal may be generated by combining two NRZ signals. Although illustrated as discrete blocks, various blocks may be divided into additional blocks, combined into fewer blocks, or eliminated, depending on the desired implementation. The method 1000 may be implemented in whole or in part by, e.g., the circuit 800 of FIG. 8.

At 1001, a first data sample may be input into a first section of a sliced architecture of current mode drivers. The first data sample may include an LSB. In some embodiments, the first data sample may further be passed through taps of delay lines of a UI FFE to generate one or more delayed data samples of the first data sample. In some embodiments, the delayed data samples of the first data sample along with the first data sample may be pre-allocated to various data selectors of the first section which may be coupled into various current mode DAC circuits of the first section to generate an NRZ encoded current from the first section. At 1002, the NRZ encoded current from the first section may be output.

At 1003, a second data sample may be input into a second section of the sliced architecture of current mode drivers. The second data sample may include an MSB. In some embodiments, the second data sample may further be passed through taps of delay lines of a UI FFE to generate one or more delayed data samples of the second data sample. In some embodiments, the delayed data samples of the second data sample along with the second data sample may be pre-allocated to various data selectors of the second section which may be coupled into various current mode DAC circuits of the second section to generate an NRZ encoded current from the second section. At 1004, the NRZ encoded current from the second section may be output.

At 1005, a third data sample may be input into a third section of the sliced architecture of current mode drivers. The third data sample may include the second data sample or a different data sample from the second data sample. For instance, the third data sample may include the MSB. In some embodiments, the third data sample may further be passed through taps of delay lines of a UI FFE to generate one or more delayed data samples of the third data sample. In some embodiments, the delayed data samples of the third data sample along with the third data sample may be pre-allocated to various data selectors of the third section which may be coupled into various current mode DAC circuits of the third section to generate an NRZ encoded current from the third section. At 1006, the NRZ encoded current from the third section may be output.

At 1007, the NRZ encoded current from the first section, the NRZ encoded current from the second section, and the NRZ encoded current from the third section may be combined to generate a total output current. In some embodiments, the total output current is a PAM4 encoded current signal. In some embodiments, the sum of the NRZ encoded current from the second section and the NRZ encoded current from the third section may have double the weight of the NRZ encoded current from the first section.

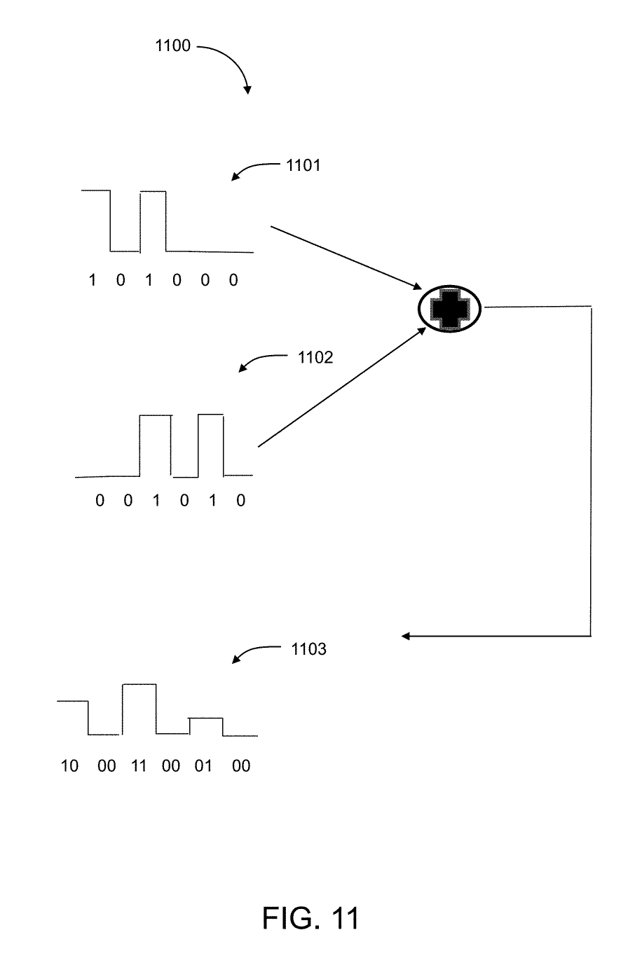

FIG. 11 is an example process 1100 of combining two parallel NRZ signals to generate a PAM4 signal. A first NRZ signal 1101 may be combined with a second NRZ signal 1102, (both having two voltage levels 0 and 1), to obtain a PAM4 signal 1103 (having 4 voltage levels 00, 01, 10, and 11). The first NRZ signal 1101 may include or correspond to a sum of the NRZ encoded currents output from the second and third sections at blocks 1004 and 1006 of FIG. 10. The second NRZ signal 1102 may include or correspond to the NRZ encoded current output from the first sections at block 1002 of FIG. 10. The first NRZ signal 1101 may include data bits for example 101000, and the second NRZ signal 1102 may include data bits for example 001010, which may be combined to obtain the PAM4 signal 1103 that includes a data bit stream of 10,00,11,00,01,00.

In the example of FIG. 11, the first NRZ signal 1101 may have double the weight of the second NRZ signal 1102. As such, the combination of a 1 bit of the first NRZ signal 1101 and a 0 bit of the second NRZ signal 1102 may have the 10 voltage level that is higher than the 01 voltage level that results from the combination of a 0 bit of the first NRZ signal 1101 and a 1 bit of the second NRZ signal 1102.

Various embodiments are disclosed. The various embodiments may be partially or completely combined to produce other embodiments.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. All of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device may include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above may be varied—for example, blocks may be re-ordered, combined, and/or broken into sub-blocks. Certain blocks or processes may be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for-purposes of example rather than limitation, and does not preclude inclusion of such modifications, variations, and/or additions to the present subject matter as would be readily apparent to one of ordinary skill in the art.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, various changes, substitutions, and alterations could be made hereto without departing from the spirit and scope of the invention.

1. A method of pre-allocating data samples to each slice of a current mode driver, the method comprising:
for M slices included in a section of a sliced architecture of the current mode driver, where the M slices include a subset of X slices and a subset of Y slices where X plus Y is less than or equal to M, hardwiring a first dynamic input of each of the M slices to receive a main data sample;
hardwiring a second dynamic input of each of the X slices to receive a first delayed data sample of the main data sample;
hardwiring a second dynamic input of each of the Y slices to receive a second delayed data sample of the main data sample;
summing outputs of A slices that are a subset of the M slices to obtain an output current of the main data sample;
summing outputs of B slices that are a subset of the X slices to obtain an output current of the first delayed data sample; and
summing the output current of the main data sample and the weighted output current of the first delayed data sample to obtain a net output current of the section.

2. The method of claim 1, further comprising generating the main data sample, the first delayed data sample, and the second delayed data sample from a digital data using a fractional Unit Interval (UI) feedforward equalizer (FFE), wherein the first delayed data sample and the second delayed data sample of the main data sample are generated by passing the main data sample to a delay line.

3. The method of claim 1, further comprising:
for each of the A slices, multiplying a slice current with the main data sample such that summing outputs of the A slices to obtain the output current of the main data sample comprises summing outputs of the A slices to obtain a weighted output current of the main data sample;
for each of the B slices, multiplying the slice current with the first delayed data sample such that:
summing outputs of the B slices to obtain the output current of the first delayed data sample comprises summing outputs of the B slices to obtain a weighted output current of the first delayed data sample; and
summing the output current of the main data sample and the output current of the first delayed data sample to obtain the net output current of the section comprises summing the weighted output current of the main data sample and the weighted output current of the first delayed data sample to obtain a net weighted output current of the section;
for each of C slices that are a subset of the Y slices, multiplying the slice current with the second delayed data sample;
summing outputs of the C slices to obtain a weighted output current of the second delayed data sample; and
summing the weighted output current of the second delayed data sample with the weighted output current of the main data sample and the weighted output current of the first delayed data sample to obtain the net weighted output current of the section.

4. The method of claim 3, further comprising:
hardwiring a second dynamic input of each of Z slices to receive a third delayed data sample of the main data sample, where the Z slices are a subset of the M slices and where a sum of X, Y, and Z is less than or equal to M;
for each of D slices that are a subset of the Z slices, multiplying the slice current with the third delayed data sample;
summing outputs of the D slices to obtain a weighted output current of the third delayed data sample; and
summing the weighted output current of the third delayed data sample with the weighted output current of the second delayed data sample, the weighted output current of the main data sample, and the weighted output current of the first delayed data sample to obtain the net weighted output current of the section.

5. The method of claim 1, wherein:
the sliced architecture is divided into at least a first section, a second section, and a third section;
each of the first section, the second section, and the third section has M slices; and
the method is performed for each of the first section, the second section, and the third section to obtain a net output current for each.

6. The method of claim 5, further comprising:
extracting and storing a least significant bit in the first section as the main data sample for the first section;
extracting and storing a most significant bit in the second section as the main data sample for the second section; and
extracting and storing the most significant bit in the third section as the main data sample for the third section.

7. The method of claim 5, wherein:
each of the net output current for the first section, the net output current for the second section, and the net output current for the third section includes non-return to zero (NRZ) encoding; and
the method further includes summing the net output current for the first section, the net output current for the second section, and the net output current for the third section to obtain a net output current with pulse amplitude modulation-4 (PAM4) encoding.

8. The method of claim 5, further comprising:
summing the net output current for the second section and the net output current for the third section to generate a first non-return to zero (NRZ) encoded output current, wherein the net output current for the first section comprises a second NRZ encoded output current; and
summing the first NRZ encoded output current and the second NRZ encoded output current to generate a pulse amplitude modulation-4 (PAM4) encoded output current, wherein a weight of the first NRZ encoded output current is twice a weight of the second NRZ encoded output current.

9. The method of claim 3, wherein:
each of the M slices includes a data selector;
each data selector includes a 4:1 data selector with two fixed or static inputs, the first dynamic input hardwired to receive the main data sample, and the second dynamic input hardwired to receive a corresponding one of multiple delayed data samples of the main data sample;
the multiple delayed data samples include the first delayed data sample and the second delayed data sample;
A data selectors of the A slices are configured to output the main data sample received at the first dynamic input of each of the A data selectors to a corresponding one of A current mode digital to analog converter (DAC) circuits included in the A slices;
the A current mode DAC circuits are configured to multiply the slice current with the main data sample in the A slices;
B data selectors of the B slices are configured to output the first delayed data sample received at the second dynamic input of each of the B data selectors to a corresponding one of B current mode DAC circuits; and
the B current mode DAC circuits are configured to multiply the slice current with the first delayed data sample in the B slices.

10. A current mode driver with a sliced architecture, comprising:
a delay line coupled to receive a main data sample and output the main data sample and multiple delayed data samples of the main data sample;
a plurality of buffers coupled to the delay line, including at least a first buffer to store the main data sample and multiple other buffers, each to store a corresponding one of the multiple delayed data samples;
M slices coupled to the plurality of buffers, each of the M slices comprising:
a corresponding one of M data selectors with a first dynamic input coupled to the first buffer and a second dynamic input coupled to a corresponding one of the multiple other buffers; and
a corresponding one of M current mode digital to analog (DAC) circuits with an input coupled to an output of the corresponding one of the M data selectors, outputs of the M current mode DAC circuits coupled together to be summed;
a first section of the sliced architecture that includes the delay line, the plurality of buffers, and the M slices, wherein the main data sample received by the delay line of the first section comprises a least significant bit of a digital data;
a second section of the sliced architecture that includes a second delay line, a second plurality of buffers, and a second set of M slices, wherein a second main data sample received by the second delay line of the second section comprises a most significant bit of the digital data; and
a third section of the sliced architecture that includes a third delay line, a third plurality of buffers, and a third set of M slices, wherein a third main data sample received by the third delay line of the third section comprises the most significant bit of the digital data.

11. The current mode driver of claim 10, wherein:
X data selectors of the M data selectors each has its second dynamic input hardwired to a first one of the multiple other buffers that is configured to store a first delayed data sample included in the multiple delayed data samples;
Y data selectors of the M data selectors each has its second dynamic input hardwired to a second one of the multiple other buffers that is configured to store a second delayed data sample included in the multiple delayed data samples; and
a sum of X and Y is less than or equal to M.

12. The current mode driver of claim 11, wherein:
Z data selectors of the M data selectors each has its second dynamic input hardwired to a third one of the multiple other buffers that is configured to store a third delayed data sample included in the multiple delayed data samples; and
a sum of X, Y, and Z is less than or equal to M.

13. The current mode driver of claim 12, wherein:
A of the M data selectors are configured to output the main data sample received at the first dynamic input of each of the M data selectors;
B of the X data selectors are configured to output the first delayed data sample received at the second dynamic input of each of the X data selectors;
C of the Y data selectors are configured to output the second delayed data sample received at the second dynamic input of each of the Y data selectors;
D of the Z data selectors are configured to output the third delayed data sample received at the second dynamic input of each of the Z data selectors; and
a sum of A, B, C, and D is less than or equal to M.

14. The current mode driver of claim 11, wherein:
the delay line includes N delay cells;
the plurality of buffers includes N buffers, each configured to respectively store the main data sample or a corresponding one of the multiple delayed data samples;
the multiple delayed data samples include N−1 delayed data samples; and
the M slices are divided into N subsets that includes at least a subset of X slices that includes the X data selectors and a subset of Y slices that includes the Y data selectors.

15. (canceled)

16. The current mode driver of claim 10, wherein:
the second delay line is coupled to receive the second main data sample and output the second main data sample and multiple delayed data samples of the second main data sample;
the second plurality of buffers is coupled to the second delay line, including at least a second buffer to store the second main data sample and multiple other second buffers, each to store a corresponding one of the multiple delayed data samples of the second main data sample;
the second set of M slices coupled to the second plurality of buffers, each of the M slices in the second set of M slices comprising:
a corresponding one of a second set of M data selectors with a first dynamic input coupled to the second buffer and a second dynamic input coupled to a corresponding one of the multiple other second buffers; and
a corresponding one of a second set of M current mode DAC circuits with an input coupled to an output of the corresponding one of the second set of M data selectors, outputs of the second set of M current mode DAC circuits coupled together to be summed;
the third delay line is coupled to receive the third main data sample and output the third main data sample and multiple delayed data samples of the third main data sample;
the third plurality of buffers is coupled to the third delay line, including at least a third buffer to store the third main data sample and multiple other third buffers, each to store a corresponding one of the multiple delayed data samples of the third main data sample; and
the third set of M slices coupled to the third plurality of buffers, each of the M slices in the third set of M slices comprising:
a corresponding one of a third set of M data selectors with a first dynamic input coupled to the third buffer and a second dynamic input coupled to a corresponding one of the multiple other third buffers; and
a corresponding one of a third set of M current mode DAC circuits with an input coupled to an output of the corresponding one of the third set of M data selectors, outputs of the third set of M current mode DAC circuits coupled together to be summed.

17. The current mode driver of claim 10, wherein each of the M current mode DAC circuits is configured to multiply a slice current with a corresponding one of the main data sample or of the multiple delayed data samples output by a corresponding one of the M data selectors.

18. A method comprising:
inputting a first main data sample into a first section of a sliced architecture of a current mode driver, wherein the first main data sample is a least significant bit;
generating a first delayed data sample based on the first main data sample;
outputting a non-return to zero (NRZ) encoded current from the first section based on at least one of the first main data sample and the first delayed data sample;
inputting a second main data sample into a second section of the sliced architecture of the current mode driver, wherein the second main data sample is a most significant bit;
generating a second delayed data sample based on the second main data sample;
outputting an NRZ encoded current from the second section based on at least one of the second main data sample and the second delayed data sample;
inputting a third main data sample into a third section of the sliced architecture of the current mode driver, wherein the third main data sample is the most significant bit;
generating a third delayed data sample based on the third main data sample;
outputting an NRZ encoded current from the third section based on at least one of the third main data sample and the third delayed data sample; and
combining the NRZ encoded current from the first section, the NRZ encoded current from the second section, and the NRZ encoded current from the third section to generate a total output current.

19. The method of claim 18, wherein:
a sum of the NRZ encoded current from the second section and the NRZ encoded current from the third section has double the weight of the NRZ encoded current from the first section; and
the total output current is a pulse amplitude modulation-4 (PAM4) current signal.

20. The method of claim 18, further comprising generating the NRZ encoded current from each of the first, second, and third section by summing:
a slice current multiplied with the corresponding first, second, or third main data sample in each of A slices included in a total of M slices of the corresponding first, second, or third section; and
the slice current multiplied with a first delayed data sample of the corresponding first, second, or third main data sample in each of B slices included in the total of M slices of the corresponding first, second, or third section, wherein a sum of A and B is less than or equal to M.
